(19) United States
(12) Patent Application Publication
(10) Pub. No.: US 2024/0249634 A1
(43) Pub. Date: Jul. 25, 2024

(54) SYSTEM AND METHOD FOR THE AUTOMATIC GRADING OF PROBLEMS WITH MATHEMATICAL EXPRESSIONS

(71) Applicant: Rajnish Kumar, An Arbor, MI (US)

(72) Inventor: Rajnish Kumar, An Arbor, MI (US)

(21) Appl. No.: 18/418,866

(22) Filed: Jan. 22, 2024

Related U.S. Application Data
(60) Provisional application No. 63/480,708, filed on Jan. 20, 2023.
(60) Provisional application No. 63/488,930, filed on Mar. 7, 2023.

(51) Int. Cl. G09B 7/02; G09B 23/02

(52) U.S. Cl. CPC G09B 7/02; G09B 23/02

(57) ABSTRACT

A system and method for the automatic grading of mathematical expressions includes importing a hand-written answer, converting the hand-written answer to a LaTeX formula, creating a model with noise to compare one or more mathematical expressions, checking the correctness of derivations between the mathematical expressions, applying machine learning and/or state estimation theory to determine the mistakes, and suggesting correct coefficients for the derivation. The system and method may further include identifying the handwriting of students using machine learning to determine whether cheating or copying has occurred.

### CROSS-REFERENCE TO RELATED APPLICATIONS

This application claims the benefit of U.S. Provisional Application Ser. No. 63/480,708 filed on Jan. 20, 2023, and further claims the benefit of U.S. Provisional Application Ser. No. 63/488,930 filed on Mar. 7, 2023, both of which are incorporated herein by reference.

### TECHNICAL FIELD

The present disclosure relates to automated grading systems. In particular, the present disclosure relates to a system and method for the automatic grading of problems with mathematical expressions in their intermediate steps and final solutions.

### BACKGROUND

From grade school through graduate studies, education requires systems of grading students' examinations and providing feedback to stimulate intellectual growth and development. The workload imposed on teachers and instructors, however, to hand grade their students' assignments and assessments can be time consuming. While teachers and instructors are aided by technologies, such as scantrons and simple software programs, these solutions are limited in scope. For example, scantrons and software programs in the art are limited to grading objective problems with multiple-choice answers or final answers presented in the form of simple integers or other easily-inputted data. Intermediate steps carried forward into the final answer cannot be readily assessed in order to verify correct problem solving and, at times, award partial credit.

In the case of computer programming assignments, for example, existing software available through platforms like MATLAB Grader or several programming courses on the platform Coursera can only grade the intermediate steps of a larger problem in the specific programming language of the grading software. For example, these types of tools each require preprogrammed assessment results for various intermediate steps required in arriving at the final solution—meaning the question is limited to a particular programming language.

Regarding STEM (science, technology, engineering, and mathematics) related fields, it is widely understood that the best methodology for learning a discipline is to actively apply the knowledge, reinforcing passive learning within the classroom. Subjective problems provide a solution for teachers to validate that students have developed the requisite knowledge of the subject, as well as the quantitative skills needed to succeed in their careers.

One of the obvious shortcomings of giving objective questions for homework, however, is that students do not apply the knowledge as rigorously as needed to develop mastery of the topics. In other words, objective questions tend to be much easier compared to subjective questions. While objective questions can be automatically graded by scantron or similar software offered across some learning management systems, subjective questions with mathematical expressions require a human to do the grading work. While larger universities may have the budget to hire more teaching assistants, smaller institutions with fewer resources place the burden on faculty members to conduct the grading.

Furthermore, traditional problems found in the back of textbooks, or commonly used in prior assessments, have increasingly been solved online and made accessible by subscription services and blogs. These online answer banks create a heightened disconnect between students' performance on homework assignments and closed book examinations.

Artificial Intelligence (AI) has recently been proposed in assisting students with math and/or grading answers. However, current AI models, such as Gemini and ChatGPT, require vast amounts of data and computational power for the model to accurately trained. Additionally, AI models often give unintelligible answers (popularly known as “hallucinations”), which may be in part due to the lack of explainability.

Accordingly, there exists a need for a software grading system that can assess subjective problems that have mathematical expressions within the intermediate steps towards the final solution, while not requiring large amounts of data and computational power. Moreover, the software grading system must provide feedback and prompts to assist students in reaching the correct answer while learning the material. The present disclosure solves these problems and others.

### SUMMARY OF EXAMPLE EMBODIMENTS

In some embodiments, a system and method for automatic grading comprises a student solving mathematical expressions by hand, an instructor importing the student's hand-written answers, including mathematical expressions, to a digital file format (e.g., PDF), executing software to convert the data in the digital file format to a digital formula (e.g., LaTeX, allowing for correct typesetting of mathematical expressions, although not required) and storing the LaTeX or other digital formula in a database for grading using grading software. The grading software is configured to create a model with noise for the mathematical expressions, which may be executed to thereby check the correctness of derivations between the mathematical expressions. In the case of incorrect derivations, the grading software applies a machine learning model and/or state estimation technique, determining mistakes between the set of equations and suggesting correct coefficients and other values within the mathematical expressions.

In some embodiments, the system and method for automatic grading further comprises comparing the handwriting of the student against a set of hand-written samples submitted by other students and identifying whether the handwriting of the student matches the hand-written samples submitted by any of the other students stored in the database. In some embodiments, the system and method for automatic grading further comprises identifying users by their handwriting via a Siamese Neural Network (SNN).

In some embodiments, a student or instructor uploads the mathematical expressions to a mobile application or website, wherein the system and method for automatic grading is provided either as a downloadable software or as a non-downloadable software as a service in the cloud.

In some embodiments, the student views, solves, and submits the mathematical expressions online or in an otherwise digital formula without the need for importing the hand-written sample.

### BRIEF DESCRIPTION OF THE DRAWINGS

FIG. 1 illustrates mathematical expressions solved by a student and imported to a digital file format;

FIG. 2 illustrates a first mathematical expression and a second mathematical expression, wherein the derivation is correct;

FIG. 3 illustrates a ratio of the sum and differences between a first mathematical expression and a second mathematical expression;

FIG. 4 illustrates a first mathematical expression and a second mathematical expression, wherein the derivation is incorrect;

FIG. 5 illustrates a ratio of the sum and differences between a first mathematical expression and a second mathematical expression where the derivation is incorrect;

FIG. 6 illustrates suggested coefficients for the variables inputted in a second mathematical expression; and

FIG. 7 illustrates a flowchart of a method of grading mathematical expressions.

### DETAILED DESCRIPTION OF EXAMPLE EMBODIMENTS

Aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Further, aspects of the present disclosure may take the form of a computer program product embodied in one or more computer readable media having computer readable program code.

Any combination of one or more computer readable media may be utilized. The computer readable media may be a computer readable signal medium or a computer readable storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium would include, but are not limited to: a universal serial bus (USB) stick, a hard disk, a random access memory (“RAM”), a read-only memory (“ROM”), a flash memory, an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain or store a program for use by or in connection with an instruction, system, apparatus, or device. More specific examples of the computer readable storage medium include, but are not limited to, smart devices, phones, tablets, wearables, X-Code software platforms, or any suitable combination of the foregoing.

Computer program code for carrying out operations for aspects of the present disclosure may be written in any combination of one or more programming languages, including, but not limited to, an object oriented programming language such as Java, Scala, Smalltalk, Eiffel, JADE, Emerald, Objective-C, C++, C #, VB.NET, Python or the like, conventional procedural programming languages, such as the “C” programming language, Visual Basic, Fortran 2003, Perl, COBOL 2002, PHP, ABAP, dynamic programming languages such as Python, PHP, HTML, AJAX, Ruby and Groovy, or other programming languages such as X-Code, or other suitable programming languages. The program code may execute entirely or partially on one or more of the devices of the system.

Each step of the disclosed invention may be implemented by computer program instructions. These computer program instructions may be provided to a processor of a general-purpose computer, special purpose computer, or other programmable data processing apparatus, such that the instructions, which execute via the processor of the computer or other programmable instruction execution apparatus, create a mechanism for implementing the functions/acts specified herein.

These computer program instructions may also be stored in a computer readable medium that, when executed, can direct a computer, other programmable data processing apparatus, or other devices to function in a particular manner, such that the instructions, when stored in the computer readable medium, produce an article of manufacture including instructions which, when executed, cause a computer to implement the function/act specified herein. The computer program instructions may also be loaded onto a computer, or other devices to cause a series of operational steps to be performed or to produce a computer implemented process that implements the functions.

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a system and method for the automatic grading of subjective problems that have mathematical expressions within their intermediate steps and final solution. A grading system is also needed that provides feedback and prompts to assist students in reaching the correct answer while learning the material. The present disclosure solves these problems and others.

In some embodiments, a system and method for automatic grading comprises a student solving mathematical expressions by hand, an instructor importing the student's hand-written answers including mathematical expressions to a digital file format, executing software to convert the data in the digital file format to a digital formula (e.g., LaTeX, allowing for correct typesetting of mathematical expressions) and storing the LaTeX or other digital formula on a database for grading using grading software. The grading software is configured to create a model with noise for the mathematical expressions, which may be executed to thereby check the correctness of derivations between the mathematical expressions. In the case of incorrect derivations, the grading software applies a machine learning model and/or state estimation technique, determining mistakes between the mathematical expressions and suggesting correct coefficients and other values within the mathematical expressions.

In some embodiments, in simple form, corrections to mathematical expressions can be suggested by comparing coefficients of each of the terms from a generalized expression. For example, Expression1 and Expression2 could be of very similar formats, with minor changes and corrections suggested just by comparing the coefficients of each of the terms from a generalized expression.

As shown in FIG. 1, in some embodiments, a student solves mathematical expressions by hand, and either the student or the grader imports the hand-written sample to a digital file format, such as by scanning or taking a photo of the handwritten answers. The importing may further be completed by optical character recognition that electronically or mechanically converts images of typed, handwritten, or printed text into machine-encoded text (e.g., Mathpix.com). Here, the hand-written sample detailing the mathematical expressions solved by the student appears on the lefthand side, the machine-encoded text appears in the center, while a conversion to the LaTeX or other digital formula appears on the righthand side. The mathematical expressions may comprise a finite combination of coefficients, variables, constants, and arithmetic operations between them. It will be appreciated that the correct answer may also be converted to LaTeX or other digital format for easy grading of the final answer.

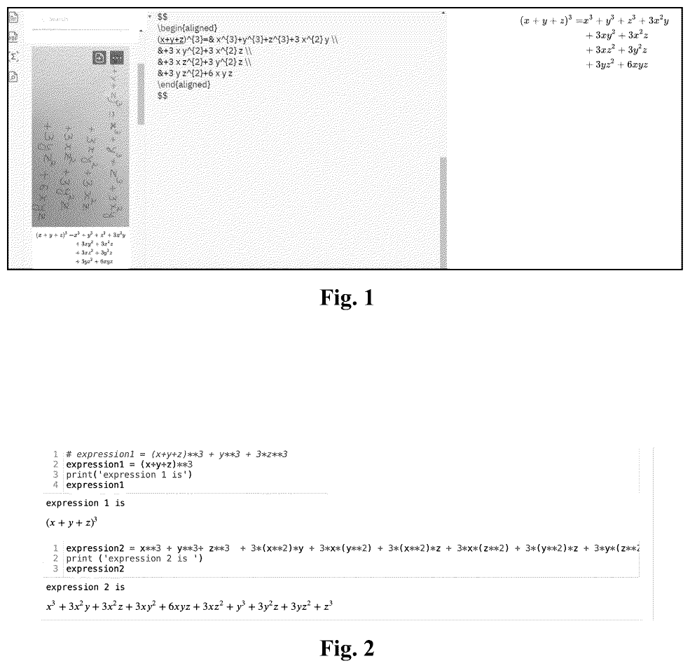

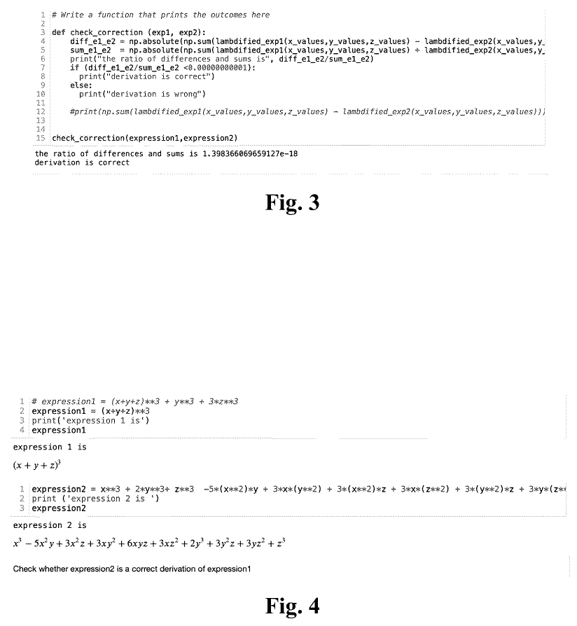

In some embodiments, a first mathematical expression may be solved to determine a derivative or other solution represented in a second mathematical expression. For example, as shown, the first mathematical expression, (x+y+z)³, is equivalent to the second mathematical expression, x³+y³+z³+3xy²+3x²z+3xz²+3y²z+3yz²+6xyz. It will be appreciated, however, that the second mathematical expression is long, and the student could potentially make several mistakes in arriving at the correct derivation from the first mathematical expression to the second mathematical expression. For example, if the student has written in the second expression that the coefficient of the factor xz² is anything other than 3, then the algorithm of the grading software will report that expression two is a wrong derivation of expression one and the correct expression should have 3 as the coefficient of factor xz². Accordingly, as shown in FIGS. 2-3, the grading software first checks the correctness between the derivations within the set of equations. In FIGS. 2-3, the derivation is deemed to be correct.

In order to check the correctness of the derivations, a model with noise may be used. For example, the model may be a dataset created using random numbers as one or more variables within the first mathematical expression to generate an array of output values for the first mathematical expression. Next, the respective random numbers are inputted as one or more variables within the second mathematical expression to generate an array of output values for the second mathematical expression. The array of output values for the first mathematical expression are then compared against the array of output values for the second mathematical expression. If a variation between the array of output values for the first and second mathematical expressions is less than a precision value (e.g., a ratio of the sum and differences between corresponding elements and a sum of the sums of corresponding elements within the arrays of values for the first and second mathematical expressions), then the derivation between the first and second mathematical expressions is deemed correct. By contrast, if the variation between the array of output values for the first and second mathematical expressions is greater than the precision value, then the derivation is deemed incorrect.

For example, in some embodiments, the grading software generates a range of random input values, between 0 and 1 (though the range could vary without limitation between any set of numbers). The grading software next generates a length, such as 10,000, to serve as a sample size for each of the variables used in the first and second mathematical expressions, in this case: x, y, and z, though the length could also vary depending on a desired margin of error. The grading software then inputs a random input value for each variable within the first and second mathematical expression to generate the corresponding array of output values. In this example, given a sample size of 10,000, both the first and second mathematical expressions will each have 10,000 different input and output values.

Checking the correctness of derivations between the mathematical expressions comprises the grading software comparing the arrays of output values for both the first and second mathematical expressions. If the first mathematical expression is close in value to the second mathematical expression, then the derivation of the second mathematical expression from the first mathematical expression is correct. By contrast, if the first mathematical expression is relatively far in value from the second mathematical expression, then the derivation of the second mathematical expression from the first mathematical expression is incorrect. The terms “close” and “far” may be defined mathematically relative to a ratio of the sum and differences between corresponding elements and a sum of the sums of corresponding elements within the arrays of values for the first and second mathematical expressions. The differences and sum could have other variations as well. For example, root mean square error, or sum of the magnitudes of all the errors, or energy of the error function, etc. The same is true for the definition of sum of the sums. The square or higher powers of these error terms will work as well. In many instances, just comparing the two expressions using a symbolic toolbox from python, Wolfram Alpha, MATHWORKS, etc. will give a difference of two expressions equal to zero.

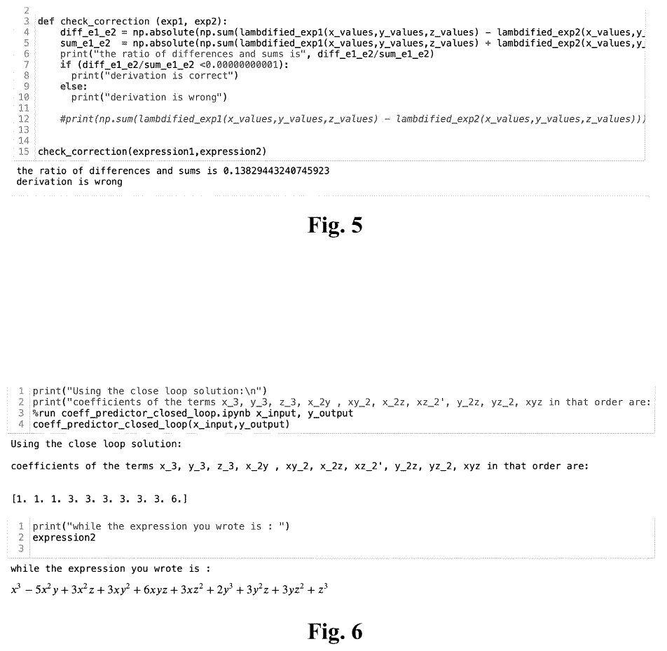

In some embodiments, if the ratio of the sum and differences is less than 1010, then the first and second mathematical expressions are considered to be close. As shown, the ratio of the sum and differences between the arrays of output values generated by the first and second mathematical expressions is 1.398366069659127e-18, which is close, meaning that the derivation was correct. For a wrong derivation, as shown in FIGS. 4-5, the ratio of the sum and differences was 0.13829443240745923. The ratio of the sum and differences becomes even more prominent as the sample size for the arrays of values for the first and second mathematical expression increases, wherein a sample size of 10 would yield greater variation as compared to a sample size of 104.

As shown in FIG. 4, the first mathematical expression, (x+y+z)³, as solved by the student and imported by the instructor, is incorrectly shown to be equivalent to the second mathematical expression: x³−5x²y+3x²z+3xy²+6xyz+3xz²+2y³+3y²z+3yz²+z³. As shown in FIG. 5, the grading software inputs a range of random numbers within the first and second mathematical expressions to generate arrays of output values, and thereafter calculates a ratio of the sum and differences based on the relationship of the arrays of output values. As noted earlier, the ratio of the sum and differences is 0.1382944320745923, a quantity greater than the precision value, indicating that the derivation is incorrect. The student has made a mistake in the second expression, inputting −5 instead of +3 for the second coefficient of the term x²y, and +2 instead of +1 for the seventh coefficient of the term y³. Next, as shown in FIG. 6, the grading software suggests correct coefficients, such as: 1. 1. 1. 3. 3. 3. 3. 3. 3. 6. in the instant example.

It will be appreciated that the system and method for automatic grading helps grade not only the final solution, but also the intermediate steps of the mathematical expressions, providing suggestions for the correct coefficients within the intermediate steps. While the above examples demonstrate a comparison between a first mathematical expression and a second mathematical expression wherein the final solution to the subjective problem is the second mathematical expression, the process may be repeated for each and every intermediate step within a subjective problem. For example, the second mathematical expression may be an intermediate step that is compared to a third mathematical expression, which in turn is then compared to a fourth mathematical expression and so on. Accordingly, the system and method for automatic grading provides immediate feedback through automated grading of any subjective problem, and also allows step marking or partial credit for intermediate steps if enabled by the instructor.

In some embodiments, an instructor may upload a correct derivation for comparison to the student's derivation. In this scenario, when the software inputs random numbers into the respective derivations, the sum of the student's derivation should be identical to the sum of the correct derivation. In the event that the sums do not match, then the student made an incorrect derivation. However, as discussed earlier herein, it is not necessary for the instructor to upload a correct derivation, as the grading software may check the student's derivation against the original mathematical expression (or against prior derivations of the original mathematical expression) to check the accuracy of the derivation. As a result, considerably less time is required for an instructor in grading submissions by students, among other benefits.

While the first and second mathematical expressions modeled throughout FIGS. 1-6 have linear coefficients, it will be appreciated that the system and method for automatic grading may be applied to all types of nonlinear equation representations as well with similar numerical method.

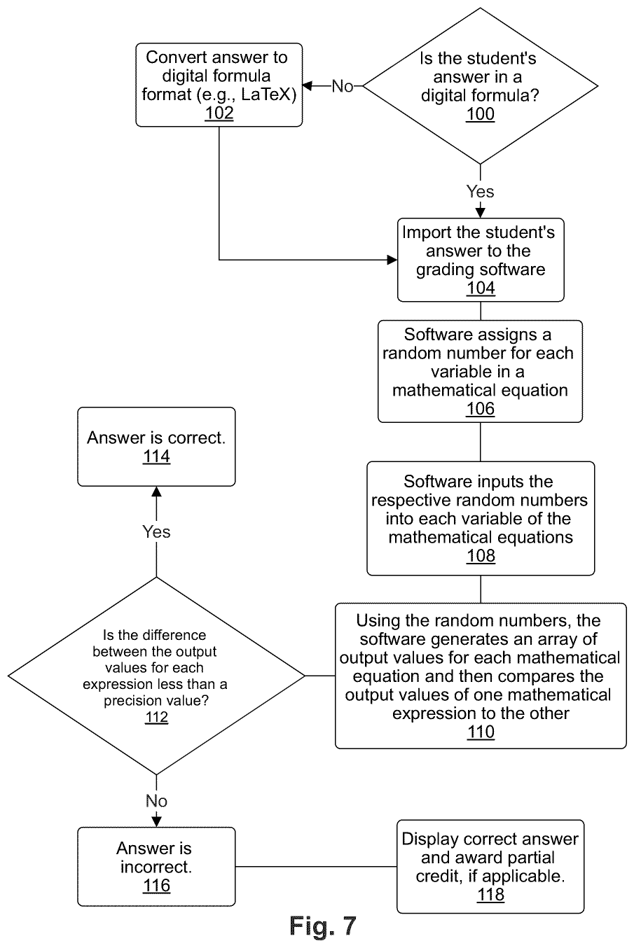

In some embodiments, referring to FIG. 7, in one method of use, an instructor will gather student answers. At step 100, the answers are reviewed to determine if the answers are in a digital formula (e.g., LaTeX) ready for grading. If not, then at step 102, a first software is used to convert the answers to a digital formula. To accomplish this, in some embodiments, the student or instructor first scans images of the mathematical expressions using a smart phone, tablet, computer, scanner, or other photo-enabled and/or copying device. The student or instructor then uploads the mathematical expressions to a mobile application or website wherein the system and method for automatic grading is provided either as a downloadable software or as a non-downloadable software as a service on the cloud.

Next, at step 104, the digital formulas are then imported into the grading software for grading. At step 106, the grading software generates a random number for each variable found in the mathematical equations present in the digital formula. At step 108, the software then inputs the respective numbers into the mathematical equations. At step 110, an array of output values is generated for each mathematical equation (e.g., derivation). The size of the array is determined by the sample size desired by the user. At step 112, the grading software then calculates the difference between the sums of the respective output values. If the sum is less than a precision value (e.g., 10⁻¹⁰), then at step 114, the answer is deemed correct. If the sum is greater than the precision value, then at step 116, the answer is deemed incorrect. If the answer is incorrect, then at step 118, machine learning model and/or state estimation techniques may be executed to determine mistakes between the set of equations and to suggest correct coefficients and other values within the mathematical expressions.

In some embodiments, the student or instructor views, solves, and uploads the mathematical expressions in a completely digital formula or other file format without importing the hand-written sample. In other words, if a student solves equations using a computer, such as in LaTeX, no scanning is required, and the grading software may execute on the inputted LaTeX formulas.

In some embodiments, the system and method for automatic grading may also comprise a learning management system, such as the services provided by Blackboard, Moodle, or Canvas, wherein the grading software also creates various kinds of statistical information related to class and/or student performance on one or more assignments and examinations. It will be appreciated that the system and method for automatic grading enables users, such as parents, without a background in the subject matter of the mathematical expressions to be able to grade problems automatically and to be able to enforce discipline and study habits in their children. In some embodiments, the system and method for automatic grading may comprise providing mathematical expressions and problems within a textbook, wherein the student can receive automatic grading software for problems in the published textbook.

The system and method for automatic grading has been disclosed herein using a simple regression analysis. However, the same steps may be implemented using other algorithms with machine learning (such as neural networks, physics informed neural networks, etc.) or state/parameter estimation techniques.

In some embodiments, the system and method for automatic grading further comprises comparing the handwriting of the student against a set of hand-written samples submitted by other students and identifying whether the handwriting of the student matches the hand-written samples submitted by any of the other students stored in the database. Matches in handwriting between hand-written samples submitted by different students would be indicative of copying or cheating. In some embodiments, the system and methods for automatic grading further comprises identifying users by their handwriting via a Siamese Neural Network (SNN).

It will be appreciated that the algorithm disclosed herein differs from Large Language Models (“LLMs,” such as ChatGPT) in that the algorithm disclosed herein includes a step-by-step derivation and is based on a well-established numerical method, requiring an exponentially less amount of computation for implementation. As discussed earlier herein, LLMs and AI have recently been proposed in assisting students with math and/or possibly be able to grading answers in future. However, current AI models, such as Gemini and ChatGPT, require vast amounts of data and computational power for the model to be accurately trained. Additionally, lack of explainability continues to be a major concern as well. While those limitations currently remain, AI is rapidly developing. Accordingly, the algorithms disclosed herein may be used in conjunction with LLMs and AI, such as ChatGPT and google Gemini etc., by implementing the algorithms disclosed herein within an internal subsystem to be used as internal detection and correction of mistakes in the derivations made by the LLM/AI.

It will be appreciated the steps in FIG. 7 may also be implemented for an internal error detection and correction system for a large language model (LLM) generated solution (e.g. ChatGPT, Google Gemini, etc.) when used as a solver for mathematical problems to further improve the performance of the LLM based solver.

While algebraic expressions have been used as examples herein, it will be appreciated that other mathematical expressions and operations may be used without departing herefrom. For example, mathematical integration may be completed using the Monte Carlo method as a well-established numerical method. The algorithms disclosed herein allow for numerical methods to be applied to other operations, including integration and other operations.

Accordingly, the system and method for automatic grading disclosed herein solves the need for a system and method for the automatic grading of subjective problems that have mathematical expressions within their intermediate steps and final solution and that further provides feedback and prompts to assist students in reaching the correct answer while learning the material. Additionally, the system and method for automatic grading allows anyone, including those not otherwise able to grade mathematical problems, to grade mathematical equations. It further allows instructors to ensure that students learn the material thoroughly while avoiding and reducing cheating.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A method for automatic grading of mathematical problems, comprising:
converting a student's hand-written answer containing mathematical expressions to a digital file format;
executing a first software program to convert the mathematical expressions of the digital file format to a digital formula;
executing a second software program to check the correctness of the mathematical expressions of the digital formula, the second software configured to create a model with noise to check the correctness of derivations between the mathematical expressions;
wherein, in the event of an incorrect derivation, the software is configured to apply a machine learning model or state estimation technique to determine mistakes between derivations and to suggest correct coefficients and other values within the mathematical expressions.

2. The method of claim 1, wherein converting the student's hand-written answer comprises using optical character recognition that electronically converts images of typed, handwritten, and printed text into machine-encoded text.

3. The method of claim 1, further comprising:
the model with noise comprising a dataset using random numbers as one or more variables within a first mathematical expression and generating a first array of output values for the first mathematical expression;
inputting the random numbers into a second mathematical expression to generate a second array of output values for the second mathematical expression; and
comparing the first array of output values to the second array of output values.

4. The method of claim 3, wherein if a variation between the first array of output values and the second array of output values is less than a precision value, then the derivation between the first and second mathematical expressions is deemed correct.

5. The method of claim 3, wherein if a variation between the first array of output values and the second array of output values is greater than a precision value, then the derivation between the first and second mathematical expressions is deemed incorrect.

6. The method of claim 4, wherein the precision value is a ratio of a sum and differences between corresponding elements and a sum of the sums of corresponding elements within the arrays of values for the first and second mathematical expressions.

7. The method of claim 6, wherein if the ratio of the sum and differences is less than 1010, then the derivation is deemed correct.

8. The method of claim 3, wherein the random numbers are between 0 and 1.

9. The method of claim 3, further comprising generating a sample size for each variable within the first and second mathematical expressions.

10. The method of claim 9, wherein the sample size is 10,000.

11. The method of claim 3, further comprising more than two mathematical expressions and comparing output values for each mathematical expression to determine the correctness of each mathematical expression.

12. The method of claim 11, wherein each mathematical expression over two is an intermediate step of the student's hand-written answer.

13. The method of claim 12, further comprising awarding partial credit based upon each correct derivation.

14. The method of claim 1, wherein the mathematical expressions are linear coefficients.

15. The method of claim 1, wherein the mathematical expressions are nonlinear equations.

16. The method of claim 1, further comprising comparing the student's hand-written answer to other students' hand-written answers to authenticate authorship.

17. The method of claim 16, wherein the hand-written answers are compared using a Siamese Neural Network.

18. A method for automatic grading of mathematical problems, comprising:
a student solving a mathematical problem by generating a plurality of mathematical expressions in a digital formula;
executing a software program to check the correctness of the plurality of mathematical expressions of the digital formula, the software program configured to:
create a dataset using random numbers;
input a random number from the dataset for each variable within a first mathematical expression of the plurality of mathematical expressions;
generate a first array of output values for the first mathematical expression;
input the random numbers from the dataset into each subsequent mathematical expression of the plurality of expressions to generate a respective array of output values for each subsequent mathematical expression; and
compare the first array of output values to the array of output values for each subsequent mathematical expression to determination if each derivation was done correctly;
wherein, in the event of an incorrect derivation, the software is configured to apply a machine learning model or state estimation technique to determine mistakes between derivations and to suggest correct coefficients and other values within the mathematical expressions.

19. The method of claim 18, further comprising generating a sample size for each variable within the respective mathematical expressions.

20. The method of claim 19, wherein the sample size is greater than 1,000.
